(19) United States
(12) Patent Application Publication
(10) Pub. No.: US 2026/0260893 A1
(43) Pub. Date: Sep. 3, 2026

(54) Electrode for Non-Aqueous Electrolyte Secondary Battery

(71) Applicant: Nissan Motor Co., Ltd., Yokohama-shi, Kanagawa (JP)

(72) Inventors: Yuka Aiso, Kanagawa (JP); Kazuki Arihara, Kanagawa (JP); Manabu Watanabe, Kanagawa (JP)

(21) Appl. No.: 19/489,486

(22) PCT Filed: Jun. 7, 2023
(86) PCT No.: PCT/IB2023/000324

§ 371 Date: Dec. 2, 2025

(51) Int. Cl. H01M 4/62; H01M 4/02; H01M 4/131; H01M 4/36; H01M 4/505; H01M 4/525; H01M 10/0585

(52) U.S. Cl. CPC H01M 4/625; H01M 4/131; H01M 4/362; H01M 4/505; H01M 4/525; H01M 4/623; H01M 10/0585; H01M 2004/021; H01M 2004/028

(57) ABSTRACT

An electrode for a non-aqueous electrolyte secondary battery contains an electrode active material layer containing an electrode active material, a binder, and a conductive aid. The binder contains a predetermined fluorine-based polymer electrolyte, and the conductive aid contains fibrous carbon, and the fibrous carbon has an aspect ratio of 45 or more. The electrode improves the rate characteristics of the non-aqueous electrolyte secondary battery.

### TECHNICAL FIELD

The present invention relates to an electrode for a non-aqueous electrolyte secondary battery.

### BACKGROUND ART

In recent years, various electric vehicles are expected to be widely used in order to solve environmental and energy problems. As an in-vehicle power source such as a power source for driving a motor, which is a key to the spread of these electric vehicles, secondary batteries have been intensively developed. As a secondary battery, a non-aqueous electrolyte secondary battery such as a lithium ion secondary battery which can be expected to have a high energy density and a high output has attracted attention.

An electrode for a non-aqueous electrolyte secondary battery generally has an electrode active material layer formed by using an electrode active material, a binder, and as necessary, a conductive aid. As the binder, polyvinylidene fluoride (PVdF) or the like is widely used, but such a binder does not have ion conductivity. Here, the ion conduction refers to a phenomenon that a charge is carried by movement of ions which are charged particles in a state where a voltage is applied, and a current flows. In order to obtain durability enough to withstand practical use, it is necessary to increase the content of the binder, and as a result, there is a problem in that the content of the binder having no ion conductivity increases, so that improvement of battery characteristics is limited.

For this problem, JP 2012-33286 A discloses a battery using a specific fluorine-based polymer electrolyte as a binder having ion conductivity. According to JP 2012-33286 A, it is considered that battery characteristics are improved and durability of a battery can be improved by using such a binder.

### SUMMARY OF INVENTION

However, as a result of investigations by the present inventors, it has been found that a non-aqueous electrolyte secondary battery using the technique described in JP 2012-33286 A may not exhibit sufficient rate characteristics.

Therefore, an object of the present invention is to provide a means for improving rate characteristics in a non-aqueous electrolyte secondary battery.

The present inventors have conducted intensive studies to solve the above problems. In the process, they have found that the above problems can be solved by using a specific fluorine-based polymer electrolyte as a binder of an electrode active material layer constituting a non-aqueous electrolyte secondary battery and using fibrous carbon having a specific aspect ratio as a conductive aid, and have completed the present invention.

That is, according to one aspect of the present invention, there is provided an electrode for a non-aqueous electrolyte secondary battery, including an electrode active material layer containing an electrode active material, a binder, and a conductive aid, in which the binder contains a fluorine-based polymer electrolyte having a structural unit represented by the following Chemical Formula 1,

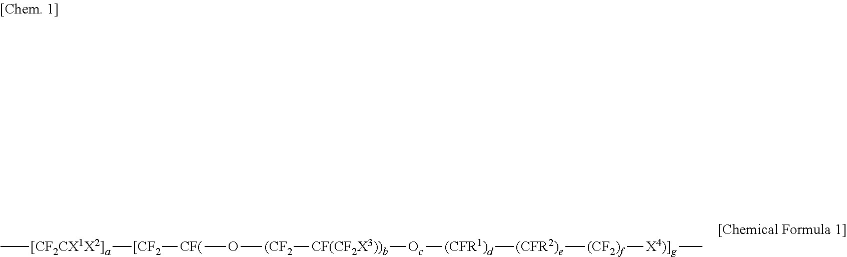

wherein
X¹, X², and X³ are each independently a halogen atom or a perfluoroalkyl group having 1 or more and 3 or less carbon atoms,
a and g are numbers satisfying 0≤a<1, 0<g≤1, and a+g=1,
b is an integer of 0 or more and 8 or less,
c is 0 or 1,
d, e, and f are each independently an integer of 0 or more and 6 or less and satisfy 0<d+e+f,
R¹ and R² are each independently a halogen atom, a perfluoroalkyl group or fluorochloroalkyl group having 1 or more and 10 or less carbon atoms,
X⁴ is COOZ, SO₃Z, PO₃Z₂, or PO₃HZ (Z is a hydrogen atom, an alkali metal atom, an alkaline earth metal atom, or an ammonium group),
in which at least a part of Z is an alkali metal atom, an alkaline earth metal atom, or an ammonium group, and
the conductive aid contains fibrous carbon, and the fibrous carbon has an aspect ratio of 45 or more.

### BRIEF DESCRIPTION OF DRAWINGS

FIG. 1 is a cross-sectional view schematically illustrating a laminate (flat) non-bipolar type (internal parallel connection type) secondary battery according to an embodiment of the present invention.

### DESCRIPTION OF EMBODIMENTS

One aspect of the present invention is an electrode for a non-aqueous electrolyte secondary battery, including an electrode active material layer containing an electrode active material, a binder, and a conductive aid, in which
the binder contains a fluorine-based polymer electrolyte having a structural unit represented by the following Chemical Formula 1,

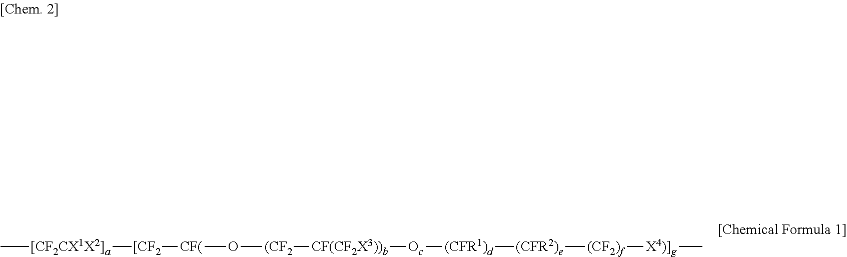

wherein
X¹, X², and X³ are each independently a halogen atom or a perfluoroalkyl group having 1 or more and 3 or less carbon atoms,
a and g are numbers satisfying 0≤a<1, 0<g≤1, and a+g=1,
b is an integer of 0 or more and 8 or less,
c is 0 or 1,
d, e, and f are each independently an integer of 0 or more and 6 or less and satisfy 0<d+e+f,
R¹ and R² are each independently a halogen atom, a perfluoroalkyl group or fluorochloroalkyl group having 1 or more and 10 or less carbon atoms,
X⁴ is COOZ, SO₃Z, PO₃Z₂, or PO₃HZ (Z is a hydrogen atom, an alkali metal atom, an alkaline earth metal atom, or an ammonium group),
in which at least a part of Z is an alkali metal atom, an alkaline earth metal atom, or an ammonium group, and
the conductive aid contains fibrous carbon, and the fibrous carbon has an aspect ratio of 45 or more.

According to the electrode for a non-aqueous electrolyte secondary battery according to the present aspect, rate characteristics can be improved in the non-aqueous electrolyte secondary battery.

Hereinafter, embodiments of the present aspect described above will be described with reference to the drawings, but the technical scope of the present invention should be determined based on the description of the claims, and is not limited to the following embodiments. Dimensional ratios in the drawings are exaggerated for convenience of description, and may be different from actual ratios. In the present specification, the phrase “X to Y” indicating a range means “X or more and Y or less”. Unless otherwise specified, operations and measurements of physical properties and the like are performed under the conditions of room temperature (20 to 25° C.)/relative humidity of 40 to 50% RH.

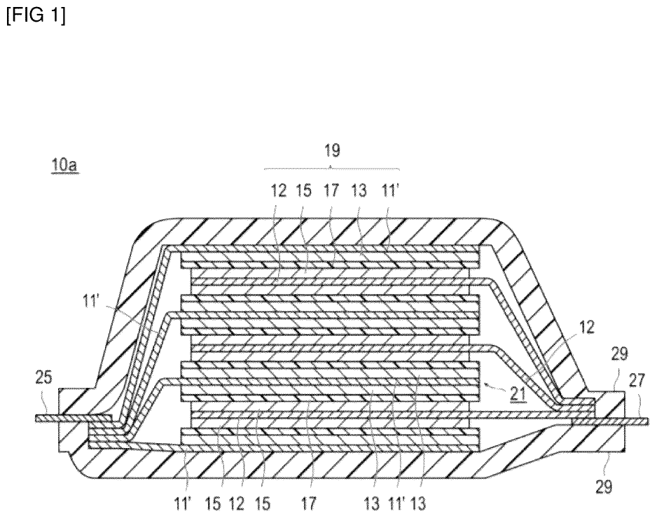

FIG. 1 is a cross-sectional view schematically illustrating a flat (laminate) non-bipolar type (internal parallel connection type) secondary battery (hereinafter, also simply referred to as “laminate type secondary battery”) as one embodiment of the present invention.

As illustrated in FIG. 1, a laminate type secondary battery 10a of the present embodiment has a structure in which a power generating element 21 having a substantially rectangular shape in which a charge-discharge reaction actually proceeds is sealed inside a laminate film 29. Here, the power generating element 21 has a configuration in which a positive electrode including a positive electrode active material layer 13 disposed on both surfaces of a positive electrode current collector 11′, an electrolyte layer 17 including a separator containing an electrolyte solution, and a negative electrode including a negative electrode active material layer 15 disposed on both surfaces of a negative electrode current collector 12 are laminated. Specifically, the positive electrode, the electrolyte layer, and the negative electrode are laminated in this order such that one positive electrode active material layer 13 and the negative electrode active material layer 15 adjacent thereto face each other with the electrolyte layer 17 interposed therebetween.

Thereby, the positive electrode, the electrolyte layer, and the negative electrode constitute one single battery layer 19. Therefore, it can be said that the laminate type secondary battery 10a illustrated in FIG. 1 has a configuration in which a plurality of single battery layers 19 are laminated to be electrically connected in parallel. Although the positive electrode active material layer 13 is disposed on only one surface of each of outermost positive electrode current collectors located in both outermost layers of the power generating element 21, the active material layer may be provided on both surfaces. That is, instead of using a current collector exclusively for an outermost layer provided with the active material layer only on one surface thereof, a current collector provided with the active material layer on both surfaces thereof may be used as it is as an outermost current collector. By reversing the arrangement of the positive electrode and the negative electrode from that in FIG. 1, the outermost negative electrode current collector may be positioned on both outermost layers of the power generating element 21, and the negative electrode active material layer may be disposed on one surface or both surfaces of the outermost negative electrode current collector.

The positive electrode current collector 11′ and the negative electrode current collector 12 have a structure in which a positive electrode current collecting plate 25 and a negative electrode current collecting plate 27 which are electrically connected to the respective electrodes (the positive electrode and the negative electrode) are respectively attached to the positive electrode current collector 11′ and the negative electrode current collector 12 and are led to an outside of the laminate film 29 so as to be sandwiched between end parts of the laminate film 29. The positive electrode current collecting plate 25 and the negative electrode current collecting plate 27 may be attached to the positive electrode current collector 11′ and the negative electrode current collector 12 of the respective electrodes with a positive electrode terminal lead and a negative electrode terminal lead (not illustrated) interposed therebetween, respectively by ultrasonic welding, resistance welding, or the like as necessary.

Hereinafter, main constituent members of the electrode for a non-aqueous electrolyte secondary battery according to the present aspect will be described. The electrode for a non-aqueous electrolyte secondary battery according to the present aspect includes an electrode active material layer essentially containing an electrode active material, a predetermined binder, and a predetermined conductive aid.

### [Current Collector]

A current collector has a function of mediating transfer of electrons from the positive electrode active material layer or the negative electrode active material layer described later. A material constituting the current collector is not particularly limited. As a constituent material of the current collector, for example, a metal or a resin having conductivity can be adopted.

Specific examples of the metal include aluminum, nickel, iron, stainless steel, titanium, copper, and the like. In addition to these, a clad material of nickel and aluminum, a clad material of copper and aluminum, or the like may be used. A foil in which a metal surface is coated with aluminum may be used. Among them, aluminum, stainless steel, copper, and nickel are preferable. Examples of the resin having conductivity include a resin obtained by adding a conductive filler to a non-conductive polymer material.

The current collector may have a single-layer structure made of a single material, or may have a laminated structure in which layers made of these materials are appropriately combined. As long as the positive electrode active material layer and the negative electrode active material layer described later have conductivity by themselves and can exhibit a current collecting function, a current collector as a member different from these electrode active material layers need not be used. In such an embodiment, the positive electrode active material layer described later as it is constitutes a positive electrode, and the negative electrode active material layer described later as it is constitutes a negative electrode.

### [Electrode Active Material Layer]

The electrode active material layer is formed on the surface of a current collector arbitrarily provided, and essentially contains an electrode active material, a specific binder, and a specific conductive aid. When the electrode according to the present aspect is a positive electrode, the electrode active material is a positive electrode active material, and when the electrode according to the present aspect is a negative electrode, the electrode active material is a negative electrode active material. In the non-aqueous electrolyte secondary battery using the electrode according to the present aspect, at least one of the positive electrode active material layer containing a positive electrode active material or the negative electrode active material layer containing a negative electrode active material may have the above characteristics. In the present specification, unless otherwise specified, matters common to the positive electrode and the negative electrode are described as “electrodes”. The electrode active material layer may further contain other components which are other than these.

### (Positive Electrode Active Material)

The positive electrode active material has a function of releasing ions such as lithium ions during charge and occluding ions such as lithium ions during discharge. In the present aspect, the type of the positive electrode active material is not particularly limited, but the positive electrode active material preferably includes the R3m space group because it has a higher capacity. The positive electrode active material belonging to the R3m space group has a predetermined layered structure (layered rock salt type structure). Therefore, by using such a positive electrode active material, the battery capacity of the non-aqueous electrolyte secondary battery can be improved.

Examples of the positive electrode active material include layered rock salt-type active materials such as LiCoO₂, LiMnO₂, LiNiO₂, LiVO₂, and Li(Ni—Mn—Co)O₂, spinel-type active materials such as LiMn₂O₄ and LiNi_{0.5}Mn_{1.5}O₄, olivine-type active materials such as LiFePO₄ and LiMnPO₄, Si-containing active materials such as Li₂FeSiO₄ and Li₂MnSiO₄, and the like. Examples of the metal oxide other than those described above include Li₄Ti₅O₁₂. Among them, a composite oxide containing lithium and nickel is preferably used, and Li(Ni—Mn—Co)O₂ and a composite oxide in which a part of these transition metals is replaced with another element (hereinafter, also simply referred to as “NMC composite oxide”) are further preferably used. The NMC composite oxide has a layered crystal structure in which a lithium atom layer and a transition metal (Mn, Ni, and Co are arranged with regularity) atom layer are alternately stacked via an oxygen atom layer, one Li atom is included per atom of transition metal M, and the extractable Li amount is twice the amount of spinel type lithium manganese oxide, that is, the supply ability is two times higher, and thus it can have high capacity.

As described above, the NMC composite oxide also includes a composite oxide in which a part of transition metal element is replaced with another metal element. Examples of the another elements in this case include Ti, Zr, Nb, W, P, Al, Mg, V, Ca, Sr, Cr, Fe, B, Ga, In, Si, Mo, Y, Sn, V, Cu, Ag, Zn, and the like.

Since the theoretical discharge capacity is high, the NMC composite oxide preferably has a composition represented by General Formula (1): LiₐNi_{b}Mn_{c}Co_{d}MₓO₂ (wherein a, b, c, d, and x satisfy 0.98≤a≤1.2, 0.6≤b≤0.9, 0<c≤0.4, 0<d≤0.4, 0≤x≤0.3, and b+c+d+x=1, and M is at least one selected from Ti, Zr, Nb, W, P, Al, Mg, V, Ca, Sr, and Cr). Here, a represents an atomic ratio of Li, b represents an atomic ratio of Ni, c represents an atomic ratio of Mn, d represents an atomic ratio of Co, and x represents an atomic ratio of M. In the electrode for a non-aqueous electrolyte secondary battery according to the present aspect, the positive electrode active material is particularly preferably an NMC composite oxide (high-nickel NMC composite oxide) satisfying 0.8≤b≤0.9, 0<c≤0.2, 0<d≤0.2, and 0≤x≤0.2 in General Formula (1) described above. When the atomic ratio of Ni is 0.8 or more, the balance between the capacity and the life characteristics is more excellent, which is preferable. When the atomic ratio of Ni is 0.9 or less, the generation of gas associated with an electrode reaction can be reduced. Therefore, the cycle durability is less likely to decrease due to the generation of gas, which is preferable. Since the high-nickel NMC composite oxide has a high capacity, the amount of lithium ions entering and leaving per the electrode active material is larger, and it is necessary to transport more lithium ions to the surface of the electrode active material, so that the effect of the present invention can be more remarkably obtained. At this time, in General Formula (1), c and d more preferably satisfy 0.05≤c≤0.2 and 0.03≤d≤0.2 from the viewpoint of improving the balance between the capacity and the life characteristics.

The average particle size of the positive electrode active material is preferably 1 to 100 μm and more preferably 1 to 20 μm from the viewpoint of increasing the output. In the present specification, as the average particle size of particles, a median diameter (D₅₀) measured by a particle size distribution measuring apparatus of a laser diffraction/scattering method is employed.

The content of the positive electrode active material in the positive electrode active material layer is not particularly limited, but for example, is preferably in a range of 60 to 99 mass %, and more preferably in a range of 80 to 98 mass %, with respect to 100 mass % of the total solid content of the positive electrode active material layer.

The electrode of the present embodiment may be a positive electrode or a negative electrode, but is preferably a positive electrode because reductive decomposition of the fluorine-based polymer electrolyte as a binder hardly occurs.

### (Negative Electrode Active Material)

The negative electrode active material has a function of releasing ions such as lithium ions during discharge and occluding ions such as lithium ions during charge. Examples of the negative electrode active material include carbon materials such as graphite, soft carbon, and hard carbon, lithium-transition metal composite oxides (for example, Li₄Ti₅O₁₂), metal materials (tin and silicon), silicon-containing alloy-based negative electrode materials (for example, Si₆₀Sn₁₀Ti₃₀), lithium alloy-based negative electrode materials (for example, a lithium-tin alloy, a lithium-silicon alloy, a lithium-aluminum alloy, a lithium-aluminum-manganese alloy, and the like), and the like. Two or more kinds of negative electrode active materials may be used in combination. From the viewpoint of the capacity and the output characteristics, a silicon-containing alloy-based negative electrode material, a carbon material, a lithium-transition metal composite oxide, and a lithium alloy-based negative electrode material are preferably used. A negative electrode active material other than the above-described negative electrode active materials may be used.

The average particle size (D₅₀) of the negative electrode active material is not particularly limited, but is preferably 1 to 100 μm and more preferably 1 to 20 μm from the viewpoint of increasing the output.

The content of the negative electrode active material in the negative electrode active material layer is, for example, 60 mass % or more and less than 100 mass %, preferably 80 mass % or more and 99.5% or less, more preferably more than 95 mass % and 99.0 mass % or less, and further preferably 97 mass % or more and 98.5 mass % or less, with respect to 100 mass % of the total solid content of the negative electrode active material layer. When the content of the negative electrode active material is in the above range, both the battery capacity and the output characteristics can be achieved.

### (Binder)

The binder has a function of maintaining the structure of the electrode active material layer by binding the members contained in the electrode active material layer to each other. In the electrode according to the present aspect, the electrode active material layer contains a binder composed of a fluorine-based polymer electrolyte described below.

### <Binder Composed of Fluorine-Based Polymer Electrolyte>

The binder contains a binder composed of a fluorine-based polymer electrolyte having a structural unit represented by the following Chemical Formula 1, in which at least a part of Z is an alkali metal atom, an alkaline earth metal atom, or an ammonium group. Here, “at least a part of Z” means 10 mol % or more of Z in the fluorine-based polymer electrolyte, and is preferably 50 mol % or more and more preferably 90 mol % or more.

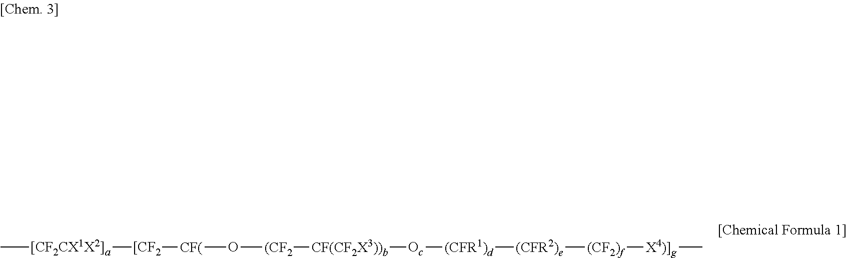

In Chemical Formula 1, X¹, X², and X³ are each independently a halogen atom or a perfluoroalkyl group having 1 or more and 3 or less carbon atoms, preferably a halogen atom, and more preferably a fluorine atom. a and g satisfy 0≤a<1, 0<g≤1, and a+g=1. Preferably, both a and g are more than 0 and less than 1. b is an integer of 0 or more and 8 or less, and preferably 1. c is 0 or 1, and preferably 1. d, e, and f are each independently an integer of 0 or more and 6 or less, and preferably an integer of 0 to 2 (where 0<d+e+f). Among them, f is preferably an integer of 1 or more, and more preferably 1 or 2. R1 and R² are each independently a halogen atom, a perfluoroalkyl group or fluorochloroalkyl group having 1 or more and 10 or less carbon atoms, and are preferably a fluorine atom or a perfluoroalkyl group having 1 or more and 10 or less carbon atoms. X⁴ is COOZ, SO₃Z, PO₃Z₂, or PO₃HZ, and preferably SO₃Z, wherein Z is a hydrogen atom, an alkali metal atom, an alkaline earth metal atom, or an ammonium group, preferably an alkali metal atom, and more preferably lithium. That is, in a preferred embodiment of the present invention, at least a part of Z is lithium. In such an aspect, the fluorine-based polymer electrolyte covers the surface of the electrode active material, thereby supplying lithium ions to the surface of the active material, increasing the reaction field, and further reducing the reaction resistance. The ammonium group is NH₄, NH₃Y¹, NH₂Y¹Y², NHY¹Y²Y³, or NY¹Y²Y³Y⁴ (Y¹, Y², Y³, and Y⁴ are an alkyl group or an aryl group).

The fluorine-based polymer electrolyte serves as an ion source for lithium ions or the like, has excellent ion conductivity, has excellent electrolyte solution transportability, and can efficiently cover the surface of the electrode active material. By covering the surface of the electrode active material, contact between the electrode active material and the electrolyte solution can be reduced, decomposition and side reactions of the electrolyte solution can be suppressed, and a uniform reaction field can be provided over a wide range on the surface of the electrode active material. Therefore, the rate characteristics can be improved by using in combination with fibrous carbon described later.

Among them, the fluorine-based polymer electrolyte as a binder is preferably a copolymer of tetrafluoroethylene (CF₂═CF₂) and perfluoro[2-(fluorosulfonylethoxy) propyl vinyl ether] (CF₂═CFOCF₂CF(CF₃)O(CF₂)₂—SO₂F) or a lithiated product thereof (a lithium salt of a hydrolyzate), and particularly preferably lithiated Nafion (Li-Nafion, Nafion is registered trademark) having a chemical structure represented by the following Chemical Formula 2. As a result, the effect of the present invention can be still more remarkably obtained.

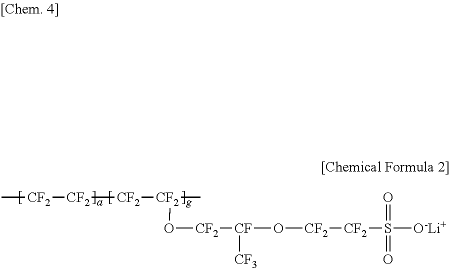

The EW of the fluorine-based polymer electrolyte is not particularly limited, but is, for example, 600 to 1500 g/eq, and preferably 600 to 1100 g/eq. In particular, when the EW is 1100 g/eq or less, since the amount of ion-exchange groups such as sulfonic acid groups is sufficiently large, the ion conductivity is improved, and the rate characteristics can be further improved, which is preferable. The EW (equivalent weight) represents the equivalent weight of an exchange group having proton conductivity. The equivalent weight is a dry weight of the fluorine-based polymer electrolyte per 1 equivalent of the ion-exchange group, and is represented by a unit of “g/eq”.

The weight average molecular weight (Mw) of the fluorine-based polymer electrolyte is not particularly limited, but is preferably 1×10³ to 1×10⁸ and more preferably 1×10⁴ to 1×10⁷. In the present specification, as the value of the weight average molecular weight (Mw), a value in terms of standard polystyrene by gel permeation chromatography (GPC) is adopted.

The fluorine-based polymer electrolyte can be produced based on the description of JP 2012-33286 A and a literature (Jin et al., RSC Advances, 2013, 3, 8889). A commercially available fluorine-based polymer electrolyte may be used.

The content of the fluorine-based polymer electrolyte in the electrode active material layer is preferably less than 3 mass %, more preferably 2.5 mass % or less, and further preferably 2 mass % or less, with respect to 100 mass % of the total solid content of the electrode active material layer. Since the binder does not directly contribute to the charge-discharge reaction, the energy density of the non-aqueous electrolyte secondary battery can be further improved by reducing the content of the binder as described above. The lower limit value is not particularly limited as long as the structure of the electrode active material layer can be maintained, but is preferably 0.3 mass % or more and more preferably 0.5 mass % or more.

### <Other Binder>

The electrode active material layer may contain a binder (hereinafter, also referred to as “other binder”) other than the binder composed of the fluorine-based polymer electrolyte. The other binder is not particularly limited, but a known material can be appropriately adopted, and examples thereof include polyvinylidene fluoride (PVdF) (including a compound in which a hydrogen atom is substituted with another halogen element), polytetrafluoroethylene (PTFE), polyimide (PI), styrene-butadiene rubber (SBR), carboxymethyl cellulose, vinylidene fluoride-hexafluoropropylene fluororubber (VDF-HFP fluororubber), and the like. From the viewpoint of further exhibiting the effect of the present invention, the content of the other binder in the electrode active material layer is preferably 10 mass % or less, more preferably 5 mass % or less, further preferably 3 mass % or less, particularly preferably 1 mass % or less, and most preferably 0 mass % (that is, the other binder is not contained), with respect to the total amount of the binder.

### (Conductive Aid)

The electrode active material layer contains fibrous carbon as a conductive aid, and the aspect ratio of the fibrous carbon is 45 or more. The conductive aid has a function of forming an electron conduction path (conductive path) in the electrode active material layer. When such an electron conduction path is formed in the electrode active material layer, the internal resistance of the battery is reduced, and the output characteristics at a high rate can be improved.

In the present specification, the “fibrous carbon” means a carbon material having a shape like a fiber. The fibrous shape includes, for example, an elongated shape such as a columnar shape, and the shape such as a linear shape and a curved shape is not particularly limited. The fibrous shape may be a tubular shape having a hollow inside as long as it has a shape like a fiber. More specifically, the “fibrous carbon” is a carbon material having a fiber length/fiber diameter of 10 or more in an observation image obtained when a cross section of the electrode active material layer is observed using a scanning electron microscope (SEM). The fiber length/fiber diameter of the fibrous carbon is, for example, 10000 or less.

The average fiber length of the fibrous carbon contained in the electrode active material layer is not particularly limited, but is, for example, 5 μm or more, preferably 7 μm or more, and more preferably 10 μm or more. When the average fiber length is 5 μm or more, the electron conduction path can be sufficiently obtained, the utilization factor of the electrode active material can be improved, and the capacity retention rate can be improved, which is preferable. The upper limit value of the average fiber length is not particularly limited, but is, for example, 100 μm or less. The average fiber length is preferably 5 to 100 μm, more preferably 7 to 50 μm, further preferably 7 to 40 μm, and particularly preferably 10 to 30 μm. By setting the average fiber length of the fibrous carbon in such a range, the conductivity between the electrode active materials can be improved, and the cycle durability can be further improved. The average fiber length of the fibrous carbon can be determined as an average value of fiber lengths of the fibrous carbon observed by photographing about 10 fields of view using a scanning electron microscope (SEM).

The average fiber diameter of the fibrous carbon is not particularly limited, but is preferably 1 to 500 nm, more preferably 1 to 400 nm, further preferably 1 to 300 nm, further more preferably 1 to 100 nm, and particularly preferably 1 to 50 nm. Within the above range, the effect of the present invention can be more remarkably obtained. The average fiber length of the fibrous carbon can be determined as an average value of fiber diameters of the fibrous carbon observed by photographing about 10 fields of view using a scanning electron microscope (SEM).

The aspect ratio of the fibrous carbon contained in the electrode active material layer is 45 or more. When the aspect ratio of the fibrous carbon is less than 45, a conductive network between the electrode active materials and between the electrode active material and the current collector is not sufficiently formed, so that the electronic resistance increases. As a result, high rate characteristics cannot be obtained. The aspect ratio of the fibrous carbon is preferably 60 or more, more preferably 100 or more, further preferably 200 or more, further more preferably 500 or more, and particularly preferably 800 or more. When the aspect ratio of the fibrous carbon is in such a range, the conductivity between the electrode active materials and between the electrode active material and the current collector can be further improved, and the rate characteristics can be further improved. The upper limit value of the aspect ratio of the fibrous carbon is not particularly limited, but is, for example, 10000 or less, preferably 5000 or less, and more preferably 2000 or less. The aspect ratio of the fibrous carbon is a value determined as the average fiber length/average fiber diameter of the fibrous carbon.

As the fibrous carbon, for example, fibrous carbon materials such as carbon nanotubes (single-walled carbon nanotubes, double-walled carbon nanotubes, multi-walled carbon nanotubes), carbon nanohorns, carbon nanofibers, carbon nanofilaments, carbon fibrils, vapor grown carbon fibers, electrospun carbon fibers, polyacrylonitrile-based carbon fibers, and pitch-based carbon fibers can be used. Among them, carbon nanotubes are preferably used. The fibrous carbon may be used singly or in combination of two or more kinds thereof.

The content of the fibrous carbon contained in the electrode active material layer is preferably 10 mass % or less, and more preferably 5 mass % or less, with respect to 100 mass % of the total solid content of the electrode active material layer. With such an upper limit value, the content of the electrode active material in the electrode active material layer is sufficiently secured, and deterioration of capacity characteristics can be suppressed. The energy density of the non-aqueous electrolyte secondary battery can be further improved. The lower limit value of the content of the fibrous carbon is not particularly limited, but is more than 0 mass % and preferably 0.1 mass % or more, preferably 0.2 mass % or more, further preferably 0.3 mass % or more, and further more preferably 1 mass % or more. With such a lower limit value, since a sufficient conductive aid for forming an electron conduction path is present, output characteristics can be further improved.

The electrode active material layer may further contain a conductive aid other than the fibrous carbon. Examples of such a conductive aid include particulate carbon materials such as acetylene black, carbon black, channel black, thermal black, and Ketjen black (registered trademark). Two or more of these may be used in combination. However, from the viewpoint of further exhibiting the effect of the present invention, the content of the conductive aid other than the fibrous carbon in the electrode active material layer is preferably 10 mass % or less, more preferably 5 mass % or less, further preferably 3 mass % or less, particularly preferably 1 mass % or less, and most preferably 0 mass % (that is, the conductive aid other than the fibrous carbon is not contained), with respect to the total amount of the conductive aid.

In the electrode for a non-aqueous electrolyte secondary battery according to the present aspect, the thickness of the electrode active material layer is not particularly limited, and conventionally known knowledge about a battery can be appropriately referred to. As an example, the thickness of the electrode active material layer is usually about 1 to 1000 μm, preferably 20 to 800 μm, more preferably 30 to 500 μm, and further preferably 30 to 200 μm. As the thickness of the electrode active material layer increases, it is possible to retain an electrode active material for exhibiting a sufficient capacity (energy density). On the other hand, as the thickness of the electrode active material layer decreases, the output characteristics can be improved (in particular, a large amount of capacity can be taken out during discharge at a high discharge rate).

As described above, the electrode for a non-aqueous electrolyte secondary battery according to the present aspect is characterized in that the electrode active material layer contains a specific fluorine-based polymer electrolyte as a binder, and contains fibrous carbon as a conductive aid, in which the aspect ratio of the fibrous carbon is 45 or more. With such a configuration, in the non-aqueous electrolyte secondary battery having the electrode according to the present aspect, the rate characteristics can be improved (in particular, a large amount of capacity can be taken out during discharge at a high discharge rate). Although the detailed mechanism by which the above effect is exhibited is unknown, the present inventors presume as follows. However, the technical scope of the present invention is not limited to the following mechanism at all.

According to the study of the present inventors, it has been found that the rate characteristics of the non-aqueous electrolyte secondary battery are significantly improved by using a predetermined fluorine-based polymer electrolyte as a binder and using a predetermined fibrous carbon as a conductive aid, as compared with the case of using a binder and a conductive aid other than these. By using fibrous carbon as a conductive aid, the conductive network between the electrode active materials and between the electrode active material and the current collector is improved, and the electronic resistance is reduced, as compared with the case of using a particulate conductive aid such as a spherical conductive aid. In addition, it is considered that the fibrous carbon and the main chain of the fluorine-based polymer electrolyte have a hydrophobic interaction, and the fluorine-based polymer electrolyte is likely to be physically adsorbed on the surface of the fibrous carbon. As a result, the dispersibility of the conductive aid in the electrode active material layer is improved, and the fluorine-based polymer electrolyte is adsorbed on the surface of the fibrous carbon in a wide range, so that the dispersibility of the fluorine-based polymer electrolyte in the electrode active material layer can also be improved. As a result, the resistance to electron conduction and movement of the electrolyte solution in the electrode active material layer can be reduced. The fluorine-based polymer electrolyte efficiently covers the surface of the electrode active material to provide a uniform reaction field, and the transfer resistance of lithium ions and electrons at the electrode interface can be reduced. These combined effects are considered to achieve a significant improvement in rate characteristics.

Here, when a fluorine-containing binder that does not have a side chain containing an ionic group, such as polyvinylidene fluoride, is used, since the hydrophobic interaction between the binders is relatively large, the ratio of aggregation of the binder is large, and it is difficult to uniformly disperse the binder on the surface of the fibrous carbon. It is considered that in the fluorine-based polymer electrolyte, the hydrophobic main chain is adsorbed by the interaction with the fibrous carbon, and the side chains having ionic groups repel each other, so that the fluorine-based polymer electrolyte is hardly aggregated.

The electrode for a non-aqueous electrolyte secondary battery according to the present aspect can improve the output characteristics of the non-aqueous electrolyte secondary battery by being applied to the non-aqueous electrolyte secondary battery. Therefore, according to another aspect of the present invention, there is provided a non-aqueous electrolyte secondary battery including a power generating element formed by laminating a positive electrode active material layer, an electrolyte layer, and a negative electrode active material layer in this order, in which at least one of the positive electrode active material layer and the negative electrode active material layer is the electrode for a non-aqueous electrolyte secondary battery according to one aspect of the present invention described above. Constituent elements other than the electrode of the non-aqueous electrolyte secondary battery will be briefly described below.

### [Electrolyte Layer]

The electrolyte layer preferably has a configuration in which the separator is impregnated with an electrolyte solution (liquid electrolyte).

### (Electrolyte Solution)

The electrolyte solution has a function as a carrier of lithium ions. The electrolyte solution has a form in which a lithium salt is dissolved in a non-aqueous solvent.

Examples of the non-aqueous solvent include dimethyl carbonate (DMC), diethyl carbonate (DEC), dipropyl carbonate (DPC), ethyl methyl carbonate (EMC), methyl propionate (MP), methyl acetate (MA), methyl formate (MF), 4-methyldioxolane (4MeDOL), dioxolane (DOL), 2-methyltetrahydrofuran (2MeTHF), tetrahydrofuran (THF), dimethoxyethane (DME), propylene carbonate (PC), butylene carbonate (BC), dimethyl sulfoxide (DMSO), γ-butyrolactone (GBL), and the like. Among them, from the viewpoint that the rapid charge characteristics and the output characteristics can be further improved, the non-aqueous solvent is preferably a chain carbonate, and more preferably at least one selected from the group consisting of diethyl carbonate (DEC), ethyl methyl carbonate (EMC), and dimethyl carbonate (DMC).

Examples of the lithium salt include Li(FSO₂)₂N (lithium bis(fluorosulfonyl)imide; LiFSI), Li(C₂F₅SO₂)₂N, LiPF₆, LiPO₂F₂, LiBF₄, LiClO₄, LiAsF₆, LiCF₃SO₃, and the like. Among them, the lithium salt preferably contains a fluorophosphate-based lithium salt such as LiPF₆ and LiPO₂F₂from the viewpoint of battery output and charge-discharge cycle characteristics. The concentration of the lithium salt in the electrolyte solution is preferably 0.1 to 3.0 mol/L, and more preferably 0.8 to 2.2 mol/L.

The electrolyte solution may further contain an additive other than the components described above. Specific examples of such a compound include ethylene carbonate, vinylene carbonate, methylvinylene carbonate, dimethylvinylene carbonate, phenylvinylene carbonate, diphenylvinylene carbonate, ethylvinylene carbonate, diethylvinylene carbonate, vinylethylene carbonate, 1,2-divinylethylene carbonate, 1-methyl-1-vinylethylene carbonate, 1-methyl-2-vinylethylene carbonate, 1-ethyl-1-vinylethylene carbonate, 1-ethyl-2-vinylethylene carbonate, vinylvinylene carbonate, allylethylene carbonate, vinyloxymethylethylene carbonate, allyloxymethylethylene carbonate, acryloxymethylethylene carbonate, methacryloxymethylethylene carbonate, ethynylethylene carbonate, propargylethylene carbonate, ethynyloxymethylethylene carbonate, propargyloxyethylene carbonate, methylene ethylene carbonate, 1,1-dimethyl-2-methylene ethylene carbonate, and the like. These additives may be used singly or in combination of two or more kinds thereof. The amount of the additive used in the electrolyte solution can be appropriately adjusted.

### (Separator)

The separator constituting the electrolyte layer has a function of holding an electrolyte and securing lithium ion conductivity between the positive electrode and the negative electrode, and a function as a partition wall between the positive electrode and the negative electrode. Examples of the form of the separator include a separator of a porous sheet made of a polymer or fiber that absorbs and holds the electrolyte solution, a nonwoven fabric separator, and the like.

The non-aqueous electrolyte secondary battery according to the present aspect can exhibit excellent output characteristics, and thus is suitably used as a power source for driving EVs and HEVs.

The following embodiments are also included in the scope of the present invention: the electrode for a non-aqueous electrolyte secondary battery according to claim 1 having the feature of claim 2; the electrode for a non-aqueous electrolyte secondary battery according to claim 1 or 2 having the feature of claim 3; the electrode for a non-aqueous electrolyte secondary battery according to any one of claims 1 to 3 having the feature of claim 4; the electrode for a non-aqueous electrolyte secondary battery according to any one of claims 1 to 4 having the feature of claim 5; the electrode for a non-aqueous electrolyte secondary battery according to any one of claims 1 to 5 having the feature of claim 6; and the non-aqueous electrolyte secondary battery according to claim 7 including the electrode for a non-aqueous electrolyte secondary battery according to any one of claims 1 to 6.

### EXAMPLES

Hereinafter, the present invention will be described in more detail with reference to Examples and Comparative Examples, but the present invention is not limited to only the following Examples.

### Example 1

### <Production of Positive Electrode>

A powder composition containing 95 parts by mass of LiNi_{0.8}Mn_{0.1}Co_{0.1}O₂ (NMC811, average particle size: 10.2 μm) as a positive electrode active material, and 3 parts by mass of multi-walled carbon nanotubes (CNT-1) having an average fiber diameter of 11 nm, an average fiber length of 10 μm, and an aspect ratio of 909 as a conductive aid was mixed at 2000 rpm for 1 minute using a planetary-stirring-type mixing kneader “Awatori Rentaro” (ARE-310, manufactured by THINKY CORPORATION). Next, an appropriate amount of N-methyl-2-pyrrolidone (NMP) as a solvent for adjusting slurry viscosity was added to the powder composition, and the mixture was mixed at 2000 rpm for 2 minutes using the same apparatus. Thereafter, lithiated Nafion (Li-Nafion) (LiTHion manufactured by Ion Power Inc., EW: 1100 g/eq, Mw: 2.3×10⁵, dispersed in isopropanol) as a binder was added to the powder composition so that lithiated Nafion was 2 parts by mass in terms of solid content, and the mixture was mixed at 2000 rpm for 4 minutes using the same apparatus, thereby producing a positive electrode slurry. The positive electrode slurry obtained above was uniformly applied onto an aluminum foil (thickness: 20 μm) placed on a smooth board using a doctor blade so that the mass (basis weight) of the positive electrode active material layer was 10 mg/cm², and dried on a hot plate at 80° C. for 1 hour. Next, the obtained laminate was pressed using a roll press machine. Thereafter, the obtained laminate was placed in a vacuum dryer and dried at 130° C. for 8 hours under vacuum conditions to produce a positive electrode of this Example. The thickness of the positive electrode active material layer in the obtained positive electrode was 31 μm, and the porosity was 25%.

### <Production of Lithium Ion Secondary Battery (Coin Cell)>

The positive electrode produced above and a counter electrode Li were opposed to each other, and two separators (made of polypropylene, thickness: 20 μm) were disposed therebetween. Next, a laminate of the positive electrode, the separator, and the counter electrode (Li metal) was disposed on the bottom side of the coin cell (CR2032, material: stainless steel (SUS316)). In order to maintain insulation property between the electrodes, a gasket was attached, an electrolyte solution was injected by a syringe, a spring and a spacer were laminated, and the upper side of the coin cell was superimposed and caulked to hermetically seal the coin cell, thereby producing a lithium ion secondary battery (coin cell) of this Example. As the electrolyte solution, an electrolyte solution obtained by dissolving 1 mol/L of LiPF₆ in a mixed solvent of ethylene carbonate (EC) and diethyl carbonate (DEC) (volume ratio: 3:7) was used.

### Example 2

A lithium ion secondary battery (coin cell) of this Example was produced by the same method as in Example 1 described above except that multi-walled carbon nanotubes (CNT-2) having an average fiber diameter of 300 nm, an average fiber length of 20 μm, and an aspect ratio of 67 were used as a conductive aid.

### Comparative Example 1

A lithium ion secondary battery (coin cell) of this Comparative Example was produced by the same method as in Example 1 described above except that multi-walled carbon nanotubes (CNT-3, VGCF (registered trademark)-H manufactured by Showa Denko K.K.) having an average fiber diameter of 150 nm, an average fiber length of 6 μm, and an aspect ratio of 40 were used as a conductive aid.

### Comparative Example 2

A lithium ion secondary battery (coin cell) of this Comparative Example was produced by the same method as in Example 1 described above except that acetylene black (AB, Li-400 manufactured by Denka Company Limited) having an average particle size (primary particle size) of 0.048 μm was used as a conductive aid.

### Comparative Example 3

A lithium ion secondary battery (coin cell) of this Comparative Example was produced by the same method as in Example 1 described above except that polyvinylidene fluoride (PVdF) (KUREHA KF Polymer #9706 manufactured by KUREHA CORPORATION, Mw: 8.8×10⁵, dispersed in NMP) was added instead of Li-Nafion so that PVdF was 2 parts by mass in terms of solid content.

### Comparative Example 4

A lithium ion secondary battery (coin cell) of this Comparative Example was produced by the same method as in Example 2 described above except that polyvinylidene fluoride (PVdF) (KUREHA KF Polymer #9706 manufactured by KUREHA CORPORATION, Mw: 8.8×10⁵, dispersed in NMP) was added instead of Li-Nafion so that PVdF was 2 parts by mass in terms of solid content.

### Comparative Example 5

A lithium ion secondary battery (coin cell) of this Comparative Example was produced by the same method as in Comparative Example 1 described above except that polyvinylidene fluoride (PVdF) (KUREHA KF Polymer #9706 manufactured by KUREHA CORPORATION, Mw: 8.8×10⁵, dispersed in NMP) was added instead of Li-Nafion so that PVdF was 2 parts by mass in terms of solid content.

### Comparative Example 6

A lithium ion secondary battery (coin cell) of this Comparative Example was produced by the same method as in Comparative Example 2 described above except that polyvinylidene fluoride (PVdF) (KUREHA KF Polymer #9706 manufactured by KUREHA CORPORATION, Mw: 8.8×10⁵, dispersed in NMP) was added instead of Li-Nafion so that PVdF was 2 parts by mass in terms of solid content.

### [Measurement of Aspect Ratio of Conductive Aid]

For the conductive aid used in each of Examples and Comparative Examples described above, the conductive aid powder was observed with a scanning electron microscope (SEM), and SEM images of 10 fields of view (each field of view includes 10 or more fibrous conductive aids) were acquired. For each conductive aid in the SEM image, the fiber length and the fiber diameter were determined. A fibrous conductive aid having a value obtained by dividing the fiber length by the fiber diameter of 10 or more was determined to be fibrous carbon. The fiber length was measured for all of those determined to be fibrous carbon in the SEM images of 10 fields of view, and the arithmetic average value was calculated and taken as the average fiber length. Similarly, the fiber diameters of all of those determined to be fibrous carbon in the SEM images of 10 fields of view were measured, and the arithmetic average value was calculated as the average fiber diameter. The value obtained by dividing the average fiber length obtained above by the average fiber diameter was taken as the aspect ratio. The value of the aspect ratio of acetylene black was set to 1. The results are shown in Table 1 below.

For the positive electrode produced in each of Examples and Comparative Examples, the cross section of the positive electrode active material layer was observed by SEM, and it was confirmed that the average fiber length, the average fiber diameter, and the aspect ratio of the fibrous carbon of the fibrous conductive aid in the positive electrode active material layer were all the same as those of the carbon nanotube as a raw material.

### [Measurement of EW of Fluorine-Based Polymer Electrolyte]

The equivalent weight EW of the lithiated Nafion as the fluorine-based polymer electrolyte used above was measured. Specifically, the fluorine-based polymer electrolyte was immersed in a saturated aqueous lithium chloride solution at 25° C. and left to stand for 30 minutes while being stirred to obtain a fluorine-based polymer electrolyte in which all terminal functional groups became lithium salts.

Protons in the saturated aqueous lithium chloride solution containing the fluorine-based polymer electrolyte turned into lithium salt were subjected to neutralization titration using a 0.01 N aqueous lithium hydroxide solution using phenolphthalein as an indicator.

The fluorine-based polymer electrolyte in which the counter ion of the ion-exchange group was in the state of a lithium ion, obtained after neutralization, was rinsed with pure water, further vacuum-dried, and weighed. The equivalent weight EW (g/eq) was determined from the following formula:

$$EW = ( W / M ) - 6$$

in consideration of a difference between the atomic weight of lithium and the atomic weight of hydrogen, where the substance amount of lithium hydroxide required for neutralization was designated as M (mmol) and the weight of the fluorine-based polymer electrolyte in which the counter ion of the ion-exchange group was in the state of a lithium ion was designated as W (mg). As a result, it was confirmed that the equivalent weight EW of the lithiated Nafion used above was 1100 g/eq.

### [Evaluation of Rate Characteristics]

The evaluation of rate characteristics was performed by installing the lithium ion secondary battery (coin cell) produced above in a thermostatic chamber (ARSF-0250-10 manufactured by ESPEC CORP.) set at 25° C. Specifically, first, as capacity confirmation at a low rate, constant current charging was performed at 0.05 C in a CCCV mode (cutoff voltage: 4.3 V). After reaching the cutoff voltage, constant voltage discharging (cutoff current: 0.01 C) was performed. Next, constant current discharging was performed to a cell voltage of 2.5 V at a discharge rate of 0.1 C in a CC mode. Under these conditions, charge and discharge evaluation was performed twice, and the discharge capacity obtained at the second time at this time was taken as a reference capacity. Next, after charging to 4.3 V at 0.05 C in the CCCV mode (cutoff current: 0.01 C), a discharging treatment was performed at a discharge rate of 3 C until the cell voltage reached 2.5 V. The charge capacity at 3 C obtained at this time was defined as an effective capacity, and the percentage of the effective capacity to the reference capacity was calculated as an effective capacity ratio [%]. The results are shown in Table 1 below.

TABLE 1
Table 1

| | Composition of positive electrode active material | | | | | | | | | |
|---|---|---|---|---|---|---|---|---|---|---|
| | layer | | | | | | | | | |
| | Positive | | | | | | | Evaluation | | |
| | electrode active | | | | | | | | | Effective |
| | material | | Binder | | Conductive aid | | | 0.1 C | 3 C | capacity |
| | | Content | | Content | | | Content | discharge | discharge | ratio (rate |
| | | (mass | | (mass | | Aspect | (mass | capacity | capacity | characteristics) |
| | Type | %) | Type | %) | Type | ratio | %) | (mAh) | (mAh) | (%) |
| Example | NMC811 | 95 | Li- | 2 | CNT- | 909 | 3 | 3.38 | 2.84 | 84.1 |
| 1 | | | Nafion | | 1 | | | | | |
| Example | NMC811 | 95 | Li- | 2 | CNT- | 67 | 3 | 3.57 | 2.69 | 75.4 |
| 2 | | | Nafion | | 2 | | | | | |
| Comparative | NMC811 | 95 | Li- | 2 | CNT- | 40 | 3 | 3.11 | 1.13 | 36.3 |
| Example | | | Nafion | | 3 | | | | | |
| 1 | | | | | | | | | | |
| Comparative | NMC811 | 95 | Li- | 2 | AB | 1 | 3 | 3.26 | 2.43 | 74.5 |
| Example | | | Nafion | | | | | | | |
| 2 | | | | | | | | | | |
| Comparative | NMC811 | 95 | PVdF | 2 | CNT- | 909 | 3 | 3.29 | 2.43 | 74.0 |
| Example | | | | | 1 | | | | | |
| 3 | | | | | | | | | | |
| Comparative | NMC811 | 95 | PVdF | 2 | CNT- | 67 | 3 | 3.29 | 2.08 | 63.2 |
| Example | | | | | 2 | | | | | |
| 4 | | | | | | | | | | |
| Comparative | NMC811 | 95 | PVdF | 2 | CNT- | 40 | 3 | 3.26 | 2.34 | 71.9 |
| Example | | | | | 3 | | | | | |
| 5 | | | | | | | | | | |
| Comparative | NMC811 | 95 | PVdF | 2 | AB | 1 | 3 | 3.49 | 2.56 | 73.2 |
| Example | | | | | | | | | | |
| 6 | | | | | | | | | | |

From the results shown in Table 1, it is found that the rate characteristics can be improved according to the electrode for a non-aqueous electrolyte secondary battery according to the present invention containing a predetermined binder and fibrous carbon having an aspect ratio of 45 or more as a conductive aid as in Examples 1 and 2. On the other hand, it is found that in the electrodes of Comparative Examples 1 and 2 in which the aspect ratio of the conductive aid is less than 45, sufficient rate characteristics cannot be achieved. It is found that sufficient rate characteristics cannot be achieved even in the electrodes of Comparative Examples 3 to 6 in which the predetermined binder is not used.

### REFERENCE SIGNS LIST

10a Laminate type secondary battery
11′ Positive electrode current collector
12 Negative electrode current collector
13 Positive electrode active material layer
15 Negative electrode active material layer
17 Electrolyte layer
19 Single battery layer
21 Power generating element
25 Positive electrode current collecting plate (positive electrode tab)
27 Negative electrode current collecting plate (negative electrode tab)
29 Laminate film

1.-7. (canceled)

8. An electrode for a non-aqueous electrolyte secondary battery, comprising:
an electrode active material layer containing an electrode active material, a binder, and a conductive aid, wherein
the binder contains a fluorine-based polymer electrolyte having a structural unit represented by Chemical Formula 1, 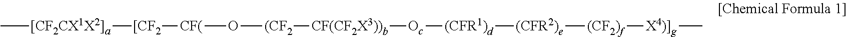
wherein
X¹, X², and X³ are each independently a halogen atom or a perfluoroalkyl group having 1 or more and 3 or less carbon atoms,
a and g are numbers satisfying 0≤a<1, 0<g≤1, and a+g=1,
b is an integer of 0 or more and 8 or less,
c is 0 or 1,
d, e, and f are each independently an integer of 0 or more and 6 or less and satisfy 0<d+e+f,
R¹ and R² are each independently a halogen atom, a perfluoroalkyl group or fluorochloroalkyl group having 1 or more and 10 or less carbon atoms,
X⁴ is COOZ, SO₃Z, PO₃Z₂, or PO₃HZ (Z is a hydrogen atom, an alkali metal atom, an alkaline earth metal atom, or an ammonium group), in which at least a part of Z is an alkali metal atom, an alkaline earth metal atom, or an ammonium group,
the conductive aid contains fibrous carbon, an aspect ratio of the fibrous carbon is 45 or more, and an average fiber length of the fibrous carbon is 7 μm or more, and
a content of the conductive aid other than the fibrous carbon in the electrode active material layer is 10 mass % or less with respect to a total amount of the conductive aid.

9. The electrode for a non-aqueous electrolyte secondary battery according to claim 8, wherein the electrode active material layer does not contain a conductive aid other than the fibrous carbon.

10. The electrode for a non-aqueous electrolyte secondary battery according to claim 8, wherein the aspect ratio of the fibrous carbon is 100 or more and 5000 or less.

11. The electrode for a non-aqueous electrolyte secondary battery according to claim 8, wherein the aspect ratio of the fibrous carbon is 800 or more.

12. The electrode for a non-aqueous electrolyte secondary battery according to claim 8, wherein at least a part of Z in the Chemical Formula 1 is lithium.

13. The electrode for a non-aqueous electrolyte secondary battery according to claim 8, wherein the fluorine-based polymer electrolyte is a copolymer of tetrafluoroethylene and perfluoro[2-(fluorosulfonylethoxy) propyl vinyl ether] or a lithiated product thereof.

14. The electrode for a non-aqueous electrolyte secondary battery according to claim 8, wherein an EW of the fluorine-based polymer electrolyte is 1100 g/eq or less.

15. The electrode for a non-aqueous electrolyte secondary battery according to claim 8, which is a positive electrode for a non-aqueous electrolyte secondary battery, wherein the electrode active material is a composite oxide having a composition represented by General Formula (1): 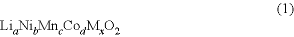
wherein a, b, c, d, and x satisfy 0.98≤a≤1.2, 0.8≤b≤0.9, 0<c≤0.2, 0<d≤0.2, 0≤x≤0.2, and b+c+d+x=1, and M is at least one element selected from Ti, Zr, Nb, W, P, Al, Mg, V, Ca, Sr, and Cr.

16. The electrode for a non-aqueous electrolyte secondary battery according to claim 8, wherein the average fiber length of the fibrous carbon is 10 μm or more.

17. A non-aqueous electrolyte secondary battery comprising a power generating element including the electrode for a non-aqueous electrolyte secondary battery according to claim 8.
